(19) United States
(12) Patent Application Publication
(10) Pub. No.: US 2008/0183793 A1
(43) Pub. Date: Jul. 31, 2008

(54) LOGIC CIRCUIT

(75) Inventor: Masahiko MOTOYAMA, Kanagawa (JP)

Correspondence Address: FOLEY AND LARDNER LLP;SUITE 500, 3000 K STREET NW, WASHINGTON, DC, 20007, US

(73) Assignee: KABUSHIKI KAISHA TOSHIBA

(21) Appl. No.: 12/019,250

(22) Filed: Jan. 24, 2008

(30) Foreign Application Priority Data
Jan. 29, 2007 (JP) 2007-018386

(51) Int. Cl. G06F 7/50

(52) U.S. Cl. 708/670

(57) ABSTRACT

A logic circuit has a decoder converting first input data into a plurality of first bit data having a constant Hamming weight regardless of the Hamming weight of the first input data, a wiring network, and an encoder converting a plurality of second bit data generated by the wiring network into at least one or at least two binary output data. The wiring network is connected to the decoder to receive the plurality of first bit data into which the first input data has been converted by the decoder and to change bit positions of the plurality of received first bit data in accordance with a control input and second input data specifying which of a first logical calculation and a second logical calculation to be executed, to change a bit pattern of the plurality of first bit data to generate a plurality of second bit data.

### CROSS REFERENCE TO RELATED APPLICATION

This application is based upon and claims the benefit of priority from the prior Japanese Patent Application No. 2007-18386 filed on Jan. 29, 2007; the entire contents of which are incorporated herein by this reference.

### BACKGROUND OF THE INVENTION

1. Field of the Invention

The present invention relates to a logic circuit, and in particular, to a logic circuit that can change a logical calculation function while inhibiting a possible variation in power consumption.

2. Description of the Related Art

With the recent advancement of LSI techniques, semiconductor devices have been widely applied to many various products including not only information apparatuses but also industrial apparatuses and home appliances.

The performance of the semiconductor device has been increasingly improved, with the power consumption of the semiconductor device increasing. Disadvantageously, the increase in power consumption may not only cause the semiconductor device to generate heat but also prevent an application product in which the semiconductor device is mounted from being used for a long time if the application product is driven by batteries, resulting in a decrease in continuous driving time.

The semiconductor device includes a large number of logic circuits in order to execute various functions. The logic circuits include general AND circuits, exclusive logical sum circuits, and adders.

However, in recent years, the basic unit of data processing, expressed in the number of bits, has been increasing from 32 bits to 64 bits. Thus, the power consumption may vary significantly depending on a variation in data being simultaneously processed. On the other hand, Japanese Patent Laid-Open No. 2000-216264 proposes a technique for reducing the power consumption of a semiconductor circuit.

Thus, disadvantageously, in the design of the semiconductor circuit, a power supply circuit must be designed in consideration of the maximum and minimum values for such a variation in power consumption depending on a variation in data.

Furthermore, for a plurality of logical calculations corresponding to different logical calculation functions, a plurality of logic circuits must be provided for the respective logical calculation functions.

### SUMMARY OF THE INVENTION

A logic circuit according to an aspect of the present invention is capable of executing a first logical calculation and a second logical calculation which have logical calculation functions different from each other, and includes a decoder converting one, or two or more first binary input data into a plurality of first bit data having a constant Hamming weight regardless of the Hamming weight of the first input data, a wiring network connected to the decoder to receive the plurality of first bit data into which the first input data has been converted by the decoder and to change bit positions of the plurality of received first bit data in accordance with a control input and second input data specifying which of the first and second logical calculations to be executed, to change a bit pattern of the plurality of first bit data to generate a plurality of second bit data, and an encoder connected to the wiring network to convert the plurality of second bit data generated by the wiring network into one, or two or more binary output data.

### BRIEF DESCRIPTION OF THE DRAWINGS

FIG. 1 is a diagram illustrating the functions of a logic circuit according to an embodiment of the present invention;

FIG. 2 is a block diagram showing the basic configuration of the logic circuit according to an embodiment of the present invention;

FIG. 3 is a circuit diagram showing the circuit configuration of the logic circuit according to the present embodiment;

FIG. 4 is a circuit diagram showing the internal circuit configuration of a switch element according to the present embodiment; and

FIG. 5 is a block diagram showing the configuration of the logic circuit in an application example of the present embodiment.

### DETAILED DESCRIPTION OF THE PREFERRED EMBODIMENTS

An embodiment of the present invention will be described below with reference to the drawings.

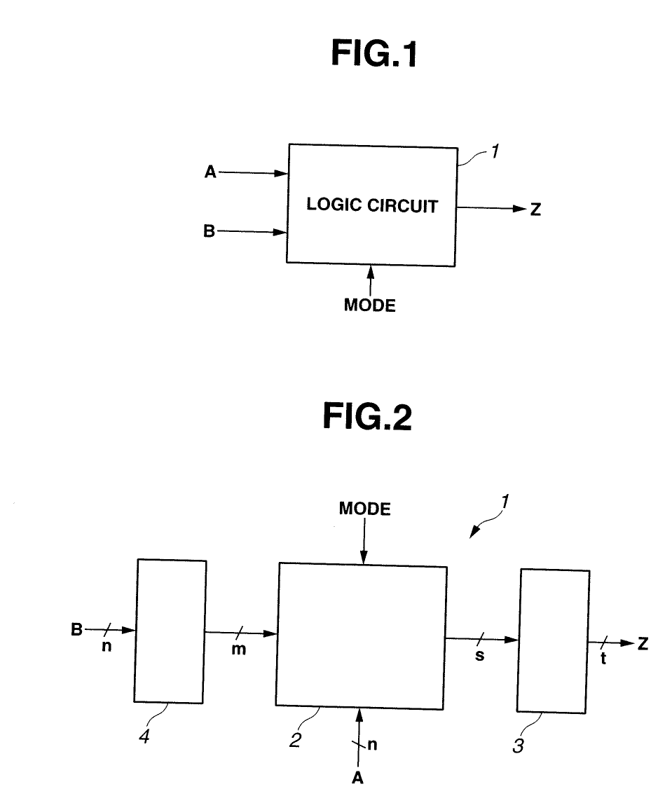

The functions of the whole logic circuit according to the present embodiment will be described with reference to FIG. 1. FIG. 1 is a diagram illustrating the functions of the logic circuit according to the present embodiment.

A logic circuit 1 according to the present embodiment executes a predetermined logical calculation on a plurality of inputs, in this case, two inputs A and B to provide an output Z for the result of the logical calculation. As described below, the logic circuit 1 can change a logical calculation function while inhibiting a possible variation in power consumption. To change the function, the logic circuit 1 has a mode input. On the basis of a signal input to the mode input, the logical calculation function to be executed by the logic circuit 1 is selected and changed. That is, the logic circuit 1 can execute a first logical calculation and a second logical calculation which use logical calculation functions different from each other. In the description of the embodiment below, two functions for the first and second logical calculations, which are different from each other, a logical product (AND) function and an exclusive logical sum (XOR) function, is selected.

FIG. 2 is a block diagram showing the basic configuration of the logic circuit 1. FIG. 2 shows a logic circuit 1 including a wiring network section (hereinafter referred to as a wiring network) 2, an encode section (hereinafter referred to as an encoder) 3, and a decode section (hereinafter referred to as a decoder) 4. The decoder 4 converts input data B, binary data of n bits, into a bit sequence of m bits (m>n).

The wiring network 2 is a wiring network circuit to which data resulting from the decoding by the decoder 4 and another input A are input and which then executes a predetermined logical calculation on the two inputs. The mode input is input to the wiring network 2 to specify which of the two logical calculations to be executed or allow one of the two logical calculations to be selected. The input A is also binary data of n bits. The encoder 3 converts s-bit data output by the wiring network 2 into t-bit data (s>t).

Here, the input data B of n bits is changed to that of m bits by being decoded, m being larger than n. This means an increase in redundancy. Moreover, the decoded data has a Hamming weight irrelevant to the Hamming weight of the input n-bit binary data, and is subsequently processed. For example, m is the nth power of 2, and the input data is converted into data such that only one signal for the m-bit data becomes HIGH (hereinafter also referred to as H). With the conversion, the decoded data always has a constant Hamming weight because only one of the wires is used for the signal that is always at the H level. That is, the decoder 4 converts the at least one or at least two first binary input data into the plurality of first bit data with the constant Hamming weight regardless of the Hamming weight of the first input data. Consequently, the power consumption of the logic circuit 1 does not depend on the input data, thereby enabling the implementation of a logic circuit that can inhibit a possible variation in power consumption.

The wiring network 2 is connected to the decoder 4 to receive a plurality of first bit data that are decode data resulting from the conversion by the decoder 4, via a plurality of input ends. On the basis of the mode input and the input data A, the wiring network 2 changes the connection between the plurality of wires or a signal path corresponding to the respective bit data of the received decode data to change the bit positions of the plurality of first bit data for a predetermined calculating process to generate a plurality of second bit data. The plurality of second bit data are output from a plurality of output ends of the wiring network 2 to the encoder 3. In other words, the wiring network 2 changes the bit pattern (the arrangement order of the plurality of bit data) of the decode data output by the decoder 4 and having the constant Hamming weight and outputs the resultant data as output data.

A specific example of the present embodiment will be described below with reference to the drawings.

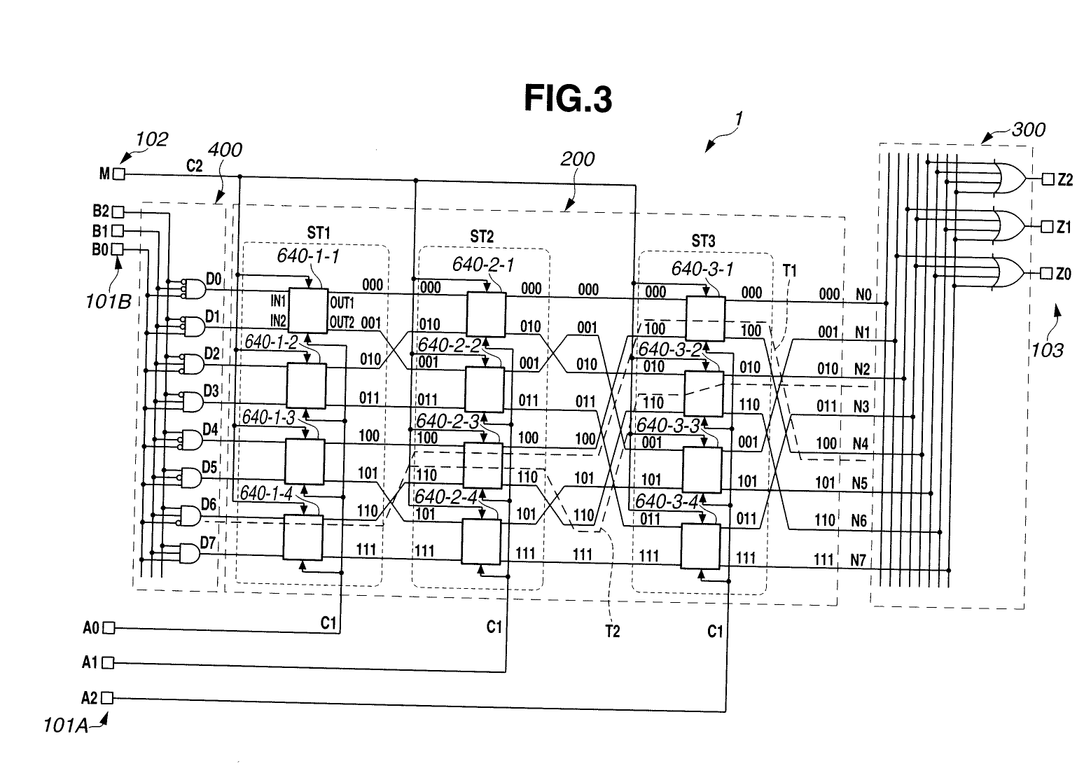

FIG. 3 is a circuit diagram showing the circuit configuration of the logic circuit according to the present embodiment. The logic circuit 1 in FIG. 3 is an example of a logic circuit having both the logical product (AND) function and the logical sum (XOR) function.

The logic circuit 1 includes an input section 101A having three input terminals (A2 to A0) through which 3-bit input data A are input, an input section 101B having three input terminals (B2 to B0) through which 3-bit input data B are input, a mode input section 102 to which the mode input specifying switching of the function is input, a decoder 400 that converts the 3-bit data into 8-bit data, a wiring network 200 that changes the 8-bit data (or wiring), an encoder 300 that converts the 8-bit data into 3-bit data, and an output section 103 having three output terminals (Z2 to Z0) from which the 3-bit data from the encoder 300 are output.

Two input data A and B each composed of 3-bit binary data and a mode input M (mode) specifying the function are input to the logic circuit 1. The logic circuit 1 executes a logical calculation based on the function specified by the mode input M to output data Z that is 3-bit binary data. The wiring network 200, the encoder 300, and the decoder 400 correspond to the wiring network 2, encoder 3, and decoder 4 respectively in FIG. 2.

In this case, the decoder 400 includes eight AND (logical product) circuits each having inverters at input terminals so that only the AND circuit provides an output for a corresponding one of eight values (0 to 7) expressed in three bits. The decoder 400 generates an output that is 8-bit decode data, from the 3-bit input. An output from each of the AND circuits in the decoder 400 is connected to a corresponding input end of the wiring network 200. Each output from the wiring network 200 is connected to the corresponding input end of the encoder 300.

In FIG. 3, for example, a first AND circuit having three inverter circuits at the respective input ends is provided such that when the 3-bit input data is (0,0,0), an output is obtained only from an output terminal D0 of the decoder 400. Furthermore, a second AND circuit having two inverter circuits at the respective input ends is provided so that when the 3-bit input data is (0,0,1), an output is obtained only from an output terminal D1 of the decoder 400. Similarly, an AND circuit having no inverter circuits at the input ends is provided so that when the 3-bit input data is (1,1,1), an output is obtained only from an output terminal D7 of the decoder 400. That is, the output from the decoder 400 is obtained by activating only one of the wires (that is, the outputs) (in this example, changing the wire to H, logic 1).

In this case, the encoder 300 includes three logical sum (OR) circuits each having a plurality of input ends connected to the respective output ends of the wiring network 200 so that the manner of the connection varies among the OR circuits and so that 3-bit data is output in association with eight values expressed in 8 bits. The encoder 300 generates the 3-bit output from the 8-bit input.

Specifically, as shown in FIG. 3, the data in outputs N7 to N4, included in the 8-bit data from the wiring network 200, are input to the first OR circuit, which directs the data to the output terminal Z2. The data in outputs N7, N6, N3, and N2 from the wiring network 200 are input to the second OR circuit, which directs the data to the output terminal Z1. The data in outputs N7, N5, N3, and N1 from the wiring network 200 are input to the third OR circuit, which directs the data to the output terminal Z0.

The wiring network 200, having both the logical product (AND) function and the exclusive logical sum (XOR) function, executes calculations required to output data on the logical product (AND) or exclusive logical sum (XOR) of the two input data A and B depending on the mode input M. That is, the mode input M makes it possible to specify which of the logical product (AND) function and the exclusive logical sum (XOR) function to be executed.

The wiring network 200 includes an input section having eight input terminals (D0 to D7), an output section having eight output terminals (N0 to N7) from which 8-bit data is output, and a conversion section that executes a predetermined conversion process on the 8-bit data to output the resultant 8-bit data.

The wiring network 200 includes a plurality of groups, that is, a plurality of (in this case, three) stages ST1, ST2, and ST3. Each of the stages ST1, ST2, and ST3 includes a plurality of switch elements 640 each with a control function (hereinafter also simply referred to switch elements). Switch elements 640-1-1, 640-1-2, 640-1-3, and 640-1-4 constitute the first stage ST1. Switch elements 640-2-1, 640-2-2, 640-2-3, and 640-2-4 constitute the second stage ST2. Switch elements 640-3-1, 640-3-2, 640-3-3, and 640-3-4 constitute the third stage ST3. In other words, the wiring network 200 has the plurality of switch elements, which are divided into the plurality of groups. The plurality of switch elements 640 in the first stage ST1 receive a plurality of bit data from the decoder 400. The plurality of switch elements 640 in the second and subsequent stages receive outputs from the corresponding switch elements 640 in the preceding stage.

Each of the switch elements has two input data (an input IN1 and an input IN2), two control inputs, and two output data (an output OUT1 and an output OUT2). Each switch element transfers each of the inputs IN1 and IN2 to one of the outputs OUT1 and OUT2 for output in accordance with the two control inputs, which are control signals.

One (A0) of the bit data of the input data A from the input section 101A is input to one (C1) of the control inputs of each of the switch elements 640-1-1, 640-1-2, 640-1-3, and 640-1-4 in the first stage. One (A1) of the bit data of the input data A from the input section 101A is input to one (C1) of the control inputs of each of the switch elements 64-2-1, 640-2-2, 640-2-3, and 640-2-4 in the second stage. One (A2) of the bit data of the input data A from the input section 101A is input to one (C1) of the control inputs of each of the switch elements 640-3-1, 640-3-2, 640-3-3, and 640-3-4 in the third stage.

The bit data of the mode input M is input to the other control input C2 of each of the switch elements in each stage. In the present embodiment, when the logic circuit 1 functions as an exclusive logical sum (XOR), the mode input M is 1. When the logic circuit 1 functions as a logical product (AND), the mode input M is 0.

The operation of the general logic circuit as a whole will be described below. When the logic circuit 1 functions as a circuit for an exclusive logical sum (XOR), however, each switch element directly outputs the two input data from the corresponding output ends as output data (that is, in FIG. 3, the two data input to the upper and lower input ends of each switch element are output from the upper and lower output ends, respectively) or redirects the two input data (that is, in FIG. 3, the two data input to the upper and lower input ends of each switch element are output from the lower and upper output ends, respectively) depending on one of the bit data of the input data A from the input section 101A.

Furthermore, when the logic circuit 1 functions as a circuit for a logical product (AND), if one of the bit data of the input data from the input section 101A, which is a control signal, is 1, the input data are directly output without redirection, that is, the data input to the upper input end is output from the upper output end, while the data input to the lower input end is output from the lower output end. Further, if one of the bit data of the input data from the input section 101A, which is a control input, is 0, the input data are redirected depending on the input data. That is, if one of the two input data is 1, the data are always output from the upper output end, while the lower output end is set to 0.

Thus, in other words, each switch element 640 is a circuit that changes the state in which the two signals IN1 and IN2 input to the respective input ends appear at the two output ends OUT1 and OUT2 in response to the two control inputs C1 and C2 input to the respective control input ends.

The signals through the eight input terminals (D0 to D7) in the input section of the wiring network 200 are input to the respective input terminals of the four switch elements 640 in the first stage ST1. The eight outputs from the four switch elements 640 in the first stage ST1 are input, via a wiring section, to the respective input ends of the four switch elements 640 in the second stage ST2. The eight outputs from the four switch elements 640 in the second stage ST2 are input, via a wiring section, to the respective input ends of the four switch elements 640 in the third stage ST3. In the wiring network 200, the first to eighth input ends are connected to the first to eighth output ends, respectively, and the wiring therein is partly changed as described below.

The wiring in the wiring section between the first and second stages ST1 and ST2 has a first wiring changing section. Specifically, as shown in FIG. 3, the wiring is changed so that the lower output end of the first switch element 640-1-1 in the first stage ST1 is connected to the upper input end of the second switch element 640-2-2 in the second stage ST2, the upper output end of the second switch element 640-1-2 in the first stage ST1 is connected to the lower input end of the first switch element 640-2-1 in the second stage ST2, the lower output end of the third switch element 640-1-3 in the first stage ST1 is connected to the upper input end of the fourth switch element 640-2-4 in the second stage ST2, and the upper output end of the fourth switch element 640-1-4 in the first stage ST1 is connected to the lower input end of the third switch element 640-2-3 in the second stage ST2.

The wiring in the wiring section between the second and third stages ST2 and ST3 has a second wiring changing section. Specifically, as shown in FIG. 3, the wiring is changed so that the lower output end of the first switch element 640-2-1 in the second stage ST2 is connected to the upper input end of the second switch element 640-3-2 in the third stage ST3, the upper output end of the second switch element 640-2-2 in the second stage ST2 is connected to the upper input end of the third switch element 640-3-3 in the third stage ST3, the lower output end of the second switch element 640-2-2 in the second stage ST2 is connected to the upper input end of the fourth switch element 640-3-4 in the third stage ST3, the upper output end of the third switch element 640-2-3 in the second stage ST2 is connected to the lower input end of the first switch element 640-3-1 in the third stage ST3, the lower input end of the third switch element 640-2-3 in the second stage ST2 is connected to the lower input end of the second switch element 640-3-2 in the third stage ST3, and the upper input end of the fourth switch element 640-2-4 in the second stage ST2 is connected to the lower input end of the third switch element 640-3-3 in the third stage ST3.

Moreover, the eight outputs from the four switch elements 640 in the third stage ST3 are connected to the first to eighth output ends, respectively. In this case, as shown in FIG. 3, the wiring between the third stage ST3 and the plurality of output terminals has a third wiring changing section so that the first to eighth output ends of the four switch elements 640 in the third stage ST3 are connected to the first, fifth, third, seventh, second, sixth, fourth, and eighth output terminals, respectively.

As described above, the wiring network 200 receives the plurality of bit data from the decoder 400 to change the bit positions of the plurality of received bit data to generate the plurality of specified and logically calculated bit data.

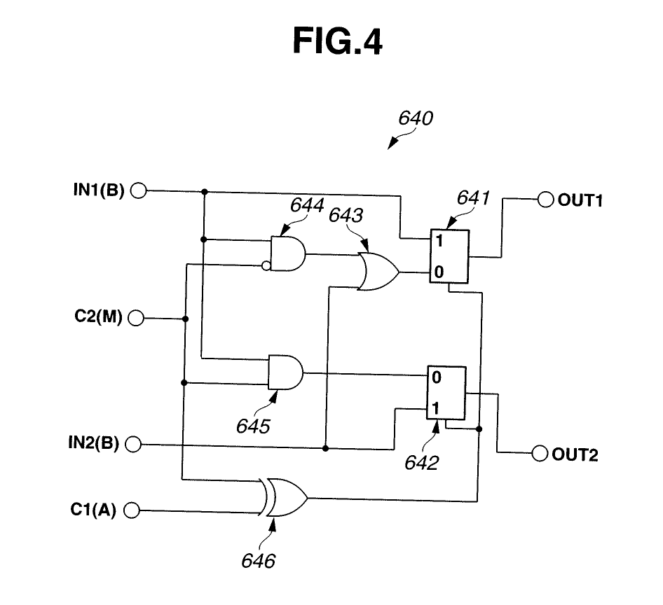

FIG. 4 is a circuit diagram showing the internal circuit configuration of the switch element 640.

As described above, the switch element 640 has the plurality of (four) input ends through which the two inputs IN1 and IN2 and the two control inputs C1 and C2 are received, and the plurality of (two) output ends through which the two outputs OUT1 and OUT2 are provided. Each switch element 640 transfers each of the inputs IN1 and IN2 to one of the outputs OUT1 and OUT2 to output in accordance with the control inputs C1 and C2, which are the control signals. The control input C1 is one of the bit data inputs of the input data A. The control input C2 is the mode input (M).

As described below, the switch element 640 is a circuit that can change the manner of outputting the plurality of input signals by outputting the bits input to the input ends from the output ends as outputs having the same pattern as that of the inputs or changing the two bits input to the input ends so that the outputs from the output ends have a pattern different from that of the inputs.

The switch element 640 includes selectors 641 and 642, a logical sum (OR) circuit 643, logical product (AND) circuits 644 and 645, and an exclusive logical sum (XOR) circuit 646.

Each of the two selectors 641 and 642 has two input ends, one output end, and one control input end. The output end of the selector 641 is connected to the output OUT1. The output end of the selector 642 is connected to the output OUT2. The control input of the selector 641 is connected to the output end of the XOR circuit 646. One of the input ends of the selector 641 is connected to the input IN1. The other input end is connected to an output end of the OR circuit 643.

One of two input ends of the OR circuit 643 is connected to an output end of the AND circuit 644. The other input end is connected to the input IN2.

One of two input ends of the AND circuit 644 is connected to the input IN1. The other input end is connected to the control input C2 corresponding to the mode input (M), via the inverter. One of two input ends of the AND circuit 645 is connected to the input IN1. The other input end is connected to the control input C2 corresponding to the mode input M.

One of two input ends of the XOR circuit 646 is connected to the control input C2 corresponding to the mode input M. The other input end is connected to the control input C1 corresponding to one of the bit data inputs of the input data A.

A plurality of the switch elements 640 in FIG. 4 are connected together to constitute the wiring network 200 as shown in FIG. 3.

The operation of the circuit in FIG. 4 will be described.

The control input C2 is connected to the mode input M. The mode input M is set to 0 to allow the logic circuit 1 to operate as a logical product (AND) circuit. The mode input M is set to 1 to allow the logic circuit 1 to operate as an exclusive logical sum (XOR) circuit.

First, description will be given of the operation of the switch element 640 performed when the logic circuit 1 operates as an exclusive logical sum (XOR) circuit.

For the exclusive logical sum (XOR) circuit, the mode input M is set to 1, that is, the control input C2 is set to 1, and one of the inputs to the AND circuit 644 is set to 0 since the input is connected to the AND circuit 644 via the inverter. Similarly, one of the inputs to the AND circuit 645 is set to 1, and one of the inputs to the XOR circuit 646 is set to 1.

In this case, when the control input C1 is 0, the output from the XOR circuit 646 is 1. When the control input C1 is 1, the output from the XOR circuit 646 is 0.

When the output from the XOR circuit 646 is 1, the selector 641 selects the input end (1) connected to the input IN1 to direct the input to the output end. Likewise, in this case, the selector 642 also selects the input end (1) connected to the input IN2 to direct the input to the output end.

Consequently, when the mode input M is 1 and the control input C1 is 0, a signal of the input IN1 at the upper input end is directed to the output OUT1 at the upper output end. A signal of the input IN2 at the lower input end is directed to the output OUT2 at the lower output end.

When the output from the XOR circuit 646 is 0, the selector 641 selects the input end (0) connected to the output end of the OR circuit 643 to direct the input to the output end. Similarly, in this case, the selector 642 selects the input end (0) connected to the output end of the AND circuit 645 to direct the input to the output end.

One of the input ends of the OR circuit 643 is connected to the output end of the AND circuit 644. The other input end of the OR circuit 643 is connected to the input IN2. Since 0 is input to one of the input ends of the AND circuit 644 via the inverter, the output from the AND circuit 644 is always 0. Thus, the output of the OR circuit 643 directs the input data of the input IN2 to the output OUT1 via the selector 641.

The selector 642 selects the input end (0) connected to the output end of the AND circuit 645 to direct the input to the output end. Since one of the input ends of the AND circuit 645 is connected to the mode input M, 1 is input to the input end. Since the other end of the AND circuit 645 is connected to the input IN1, the output of the AND circuit 645 directs the input data of the input IN1 to the output OUT2 via the selector 642.

Consequently, when the mode input M is 1 and the control input C1 is 1, the signal of the input IN1 at the upper input end is directed to the output OUT2 at the lower output end. The signal of the input IN2 at the lower input end is directed to the output OUT1 at the upper output end.

That is, when the logic circuit 1 is allowed to operate as an exclusive logical sum (XOR) circuit, the control input C2 is 1. In the switch element 640, in accordance with the control input C1, the inputs IN1 and IN2 are directed to the outputs OUT1 and OUT2 or the outputs OUT2 and OUT1, respectively.

Now, description will be given of the operation of the switch element 640 performed when the logic circuit 1 operates as a logical product (AND) circuit.

For the logical product (AND) circuit, the mode input M is set to 0, that is, the control input C2 is set to 0, and one of the inputs to the AND circuit 644 is set to 1 since the input is connected to the AND circuit 644 via the inverter. Similarly, one of the inputs to the AND circuit 645 is set to 0, and one of the inputs to the XOR circuit 646 is set to 0.

In this case, when the control input C1 is 1, the output from the XOR circuit 646 is 1. When the control input C1 is 0, the output from the XOR circuit 646 is 0.

As described above, when the output from the XOR circuit 646 is 1, the selector 641 selects the input end (1) connected to the input IN1 to direct the input to the output end. Likewise, in this case, the selector 642 also selects the input end (1) connected to the input IN2 to direct the input to the output end.

Consequently, when the mode input M is 0 and the control input C1 is 1, the signal of the input IN1 at the upper input end is directed to the output OUT1 at the upper output end. The signal of the input IN2 at the lower input end is directed to the output OUT2 at the lower output end.

When the output from the XOR circuit 646 is 0, the selector 641 selects the input end (0) connected to the output end of the OR circuit 643 to direct the input to the output end. Similarly, in this case, the selector 642 also selects the input end (0) connected to the output end of the AND circuit 645 to direct the input to the output end.

One of the input ends of the OR circuit 643 is connected to the output end of the AND circuit 644. The other input end of the OR circuit 643 is connected to the input IN2. Since 1 is input to one of the input ends of the AND circuit 644 via the inverter, the output of the AND circuit 644 directs the input data of the input IN1 to one of the input ends of the OR circuit 643. Furthermore, the input IN2 is input to the other input end of the OR circuit 643. However, since only one of the eight outputs from the decoder 400 is 1, both the inputs IN1 and IN2 are 0 or one of the inputs is 1, while the other is 0. Consequently, the output from the OR circuit 643 is 1 when one of the inputs IN1 and IN2 is 1. The output from the OR circuit 643 is 0 when both the inputs IN1 and IN2 are 0.

The selector 642 selects the input end (0) connected to the output end of the AND circuit 645 to direct the input to the output end. Since one of the input ends of the AND circuit 645 is connected to the mode input M, the output from the AND circuit 645 is always 0. Thus, the output from the AND circuit 645, 0, is directed to the output OUT2 via the selector 642.

Consequently, when the mode input M is 0 and the control input C1 is 0, provided that one of the two inputs IN1 and IN2 is 1, 1 is directed to the output OUT1 at the upper output end, and 0 is directed to the output OUT2 at the lower output end.

That is, when the logic circuit 1 is allowed to operate as a logical product (AND) circuit, the control input C2 is 0. In the switch element 640, when the control input C1 is 1, the inputs IN1 and IN2 are directed to the outputs OUT1 and OUT2. When the control input C1 is 0 and one of the inputs IN1 and IN2 is 1, 1 is directed to the output OUT1.

Now, the operation of the logic circuit 1 configured as described above will be described below.

First, description will be given of the operation of the logic circuit 1 functioning as an exclusive logical sum (XOR) circuit.

For example, when the input data B is 110 and the input data A is 010, the logic circuit 1 outputs 100.

In this case, when 110 is input as the input data B, an output is provided only through an output terminal D6 of the decoder 400. The decoder 400 thus outputs 01000000. The least significant bit of the input data A, 0, is input to the first stage ST1 as a control signal. Since the control input C1 for the first stage ST1 is 0, the first stage ST1 directly outputs the data. Consequently, the four switch elements 640 in the first stage ST1 output 01000000.

When the output from the first stage ST1 is input to the second stage ST2, the wiring connection between the first stage ST1 and the second stage ST2 changes the positions of the second and third bits to each other and the positions of the sixth and seventh bits to each other. Thus, 0010000 is input to the second stage ST2. Since the control signal C1 for the second stage ST2 is 1, the positions of the adjacent bits in the input data are changed to each other. The four switch elements 640 in the second stage ST2 output 00010000.

When the output from the second stage ST2 is input to the third stage ST3, the wiring connection between the second stage ST2 and the third stage ST3 allows 00000010 to be input to the third stage ST3. Since 0 is input to the third stage ST3 as the control signal C1, the third stage directly outputs the input data, 00000010. In the final stage of the wiring network 200, the positions of the bits are further changed. Finally, 00010000 is output. In FIG. 3, the path of the input data in the wiring network 200 is shown by a dotted line. The encoder 300 encodes 00010000 into 100. The data of 100 is obtained by calculating the exclusive logical sum of the two inputs 110 and 010.

As described above, for the mode input M of 1, the exclusive logical sum of the two input data is output.

Now, description will be given of the operation of the logic circuit 1 functioning as a logical product (AND) circuit.

For example, when the input data B is 110 and the input data A is 010, the logic circuit 1 outputs 010.

In this case, when 110 is input as the input data B, an output is provided only through the output terminal D6 of the decoder 400. The decoder 400 thus outputs 01000000. The least significant bit of the input data A, 0, is input to the first stage ST1 as a control signal. Since the control input C1 for the first stage ST1 is 0, each switch element 640 outputs 1 through the upper output end when one of the inputs thereto is 1. Consequently, since one of the inputs to the switch element 640-1-4 is 1, the four switch elements 640 in the first stage ST1 output 01000000.

When the output from the first stage is input to the second stage ST2, the wiring connection between the first stage ST1 and the second stage ST2 changes the positions of the second and third bits to each other and the positions of the sixth and seventh bits to each other. Thus, 0010000 is input to the second stage ST2. Since the control signal C1 for the second stage ST2 is 1, the signal input to the upper input end IN1 of each switch element 640 is directed to the upper output end OUT1. The signal input to the lower input end IN2 of each switch element 640 is directed to the lower output end OUT2. Thus, the four switch elements 640 in the second stage ST2 output 00100000.

When the output from the second stage ST2 is input to the third stage ST3, the wiring connection between the second stage ST2 and the third stage ST3 allows 00001000 to be input to the third stage ST3. Since 0 is input to the third stage ST3 as the control signal C1, each switch element 640 outputs 1 through the upper output end when one of the inputs thereto is 1. Consequently, since one of the inputs to the switch element 640-3-2 is 1, the four switch elements 640 in the third stage ST3 output 00000100. In the final stage of the wiring network 200, the positions of the bits are further changed. Finally, 00000100 is output. In FIG. 3, the path of the input data in the wiring network 200 is shown by a dotted line T2. The encoder 300 encodes 00000100 into 010. The data of 010 is obtained by calculating the logical product of the two inputs 110 and 010.

Thus, for the mode input M of 0, the logical product of the two input data is output.

As described above, in the logic circuit 1, the decoder 400 decodes one of the two input data, that is, the input data B, into such a decode data that sets only one of the plurality of output terminals to H and outputs the input data B to the wiring network 200. On the basis of the control inputs C1 and C2, the wiring network 200 changes the bit pattern of the decode data so as to change the arrangement order of the plurality of input bit data or the wiring order corresponding to the data at the plurality of output terminals. The wiring network 200 then outputs the resultant data to the encoder 300. At this time, only one of the plurality of output data is H, whereas the other output data are L. The encoder 300 then encodes the output from the wiring network 200 into predetermined data. The predetermined logical calculation is thus executed.

Furthermore, the wiring network 200 is configured to be able to execute the two logical calculation functions. Specifically, the wiring network 200 is configured so as to change the operation of each of the switch elements 640 in the wiring network 200 on the basis of the signal for the mode input M.

To execute the exclusive logical sum (XOR) and logical product (AND) functions as described above, the conventional art provides two circuits, an exclusive logical sum circuit and a logical product circuit. Each of these circuits is controlled so as to operate in association with the corresponding function. This increases the circuit area of the semiconductor device.

However, to allow the single wiring network to execute the two functions, the above-described present embodiment configures the wiring network such that the operation of each of the switch elements is varied depending on the mode input. This allows the single logic circuit to execute the two logical calculation functions. This in turn enables a reduction in the circuit area of the semiconductor device in which the logical circuit is mounted.

In the logic circuit 1 configured as described above, the wiring network 200 always processes only one H-level signal. This prevents the power consumption from relying on the input data, while enabling the two logical calculations to be executed.

In the above description, the decoder sets only one signal to 1, that is, H. However, the logic circuit may be configured so as to set a given number of plural signals to H, with a constant power consumption, that is, to set the Hamming weight to a predetermined value of at least 2.

Now, an application example of the present embodiment will be described.

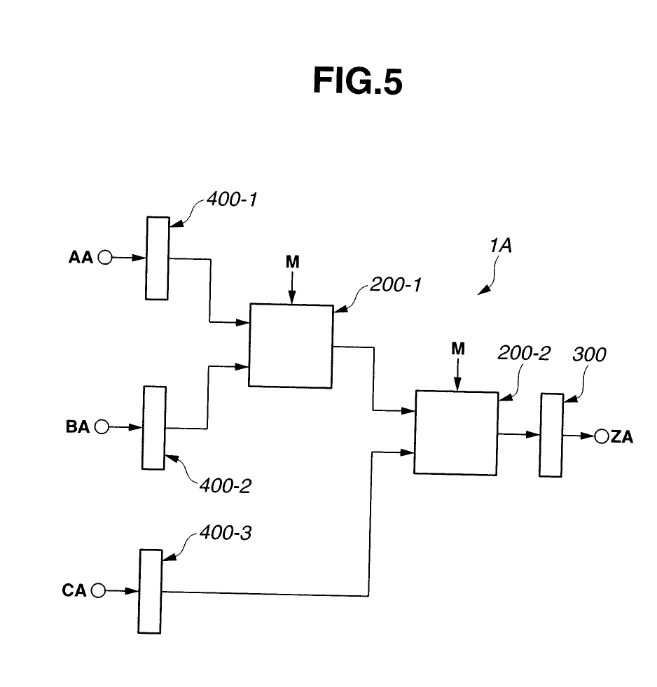

FIG. 5 is a block diagram showing the configuration of a logic circuit according to the application example of the present embodiment. The logic circuit in the present application example can execute more complicated logical calculations, that is, combinations of logical calculations. A logic circuit 1A in FIG. 5 can execute various combinations of the exclusive logical sum (XOR) and logical product (AND) for three inputs. The logic circuit 1A includes three decoders 400-1, 400-2, and 400-3, two wiring networks 200-1 and 200-2, and an encoder 300. The two wiring networks 200-1 and 200-2 are configured similarly to the wiring network 200 described above. The wiring networks are individually provided with the mode input.

In FIG. 5, three inputs AA, BA, and CA are decoded by the respective decoders 400-1, 400-2, and 400-3. Outputs from the decoders 400-1 and 400-2 are input to the wiring network 200-1. An output from the wiring network 200-1 and an output from the decoder 400-3 are input to the wiring network 200-2. An output from the wiring network 200-2 is input to the encoder 300. The decoders 400-2 and 400-3 output data such as the input data A, described above with reference to FIG. 3. If the input data BA and CA are similar to the input data A in FIG. 3, the decoders 400-2 and 400-3 may be omitted.

According to this configuration, the logic circuit 1A executes a combination of logical calculations as shown below to output output data ZA as the result of the logical calculations.

(AA*BA)+CA (1)

(AA*BA)*CA (2)

(AA+BA)+CA (3)

(AA+BA)*CA (4)

In this case, “*” denotes the logical product and “+” denotes the exclusive logical sum.

That is, each of the wiring networks 200-1 and 200-2 can execute the calculation of one of the exclusive logical sum (XOR) and the logical product (AND). Thus, the logic circuit 1A can execute the logical calculation shown in Formula (1) by providing each of the two wiring networks 200-1 and 200-2 with the mode input M so that the wiring network 200-1 executes the calculation of the logical product (AND), while the wiring network 200-2 executes the calculation of the exclusive logical sum (XOR).

The logic circuit 1A can execute the logical calculation shown in Formula (2) by providing each of the two wiring networks 200-1 and 200-2 with the mode input M so that the wiring networks 200-1 and 200-2 execute the calculation of the logical product (AND).

The logic circuit 1A can execute the logical calculation shown in Formula (3) by providing each of the two wiring networks 200-1 and 200-2 with the mode input M so that the wiring networks 200-1 and 200-2 execute the calculation of the exclusive logical sum (XOR).

The logic circuit 1A can execute the logical calculation shown in Formula (4) by providing each of the two wiring networks 200-1 and 200-2 with the mode input M so that the wiring network 200-1 executes the calculation of the exclusive logical sum (XOR), while the wiring network 200-2 executes the calculation of the logical product (AND).

Thus, in the present application example, each of the two wiring networks can execute the two logical calculation functions. The single logic circuit can thus execute the functions for the combinations of the logical calculations. This enables a reduction in the circuit area of the semiconductor device in which the logic circuit is mounted. Moreover, in the logic circuit 1A, each wiring network always processes only one H-level signal, thereby preventing the power consumption from relying on the input data.

The application example involves three input data. However, even as with four or more input data, a combination of a plurality of wiring networks allows a single logic circuit to execute complicated logical calculation functions.

As described above, the present embodiment and application example can implement a logic circuit that can change the logical calculation function while inhibiting a possible variation in power consumption.

In the above description of the embodiment, the logic circuit can execute the two logical calculation functions. In the description of the application example, the logic circuit is constructed by combining the wiring networks in the logic circuits each capable of executing the two logical calculation functions.

In the embodiment and application example, the two logical calculations are the exclusive logical sum (XOR) and logical product (AND) functions by way of example.

However, the logic circuit may be configured to be able to execute the functions for other logical calculations, for example, a logical sum (OR), in addition to the two logical calculations. Moreover, the logic circuit may be constructed by combining the wiring networks in the logic circuits each capable of executing the two logical calculation functions.

The logic circuit may be configured to be able to execute the functions for at least three logical calculations including the logical sum (OR). Moreover, the logic circuit may be constructed by combining the wiring networks in the logic circuits each capable of executing the at least three logical calculation functions. In this case, the operation of each of the switch elements in each wiring network is varied in association with the at least three logical calculations.

This increases the degree of freedom of a complicated logical calculation achieved by a combination of a plurality of wiring networks as shown in FIG. 5 by way of example as well as a combination of complicated logical calculations.

The present invention is not limited to the above-described embodiment. Various changes, modifications, or the like may be made to the embodiment without departing from the scope of the present invention.

What is claimed is:

1. A logic circuit capable of executing a first logical calculation and a second logical calculation based on logical calculation functions different from each other, the logic circuit comprising:
a decoder converting one, or two or more first binary input data into a plurality of first bit data having a constant Hamming weight regardless of the Hamming weight of the first input data;
a wiring network connected to the decoder to receive the plurality of first bit data into which the first input data has been converted by the decoder and to change bit positions of the plurality of received first bit data in accordance with a control input and second input data specifying which of the first and second logical calculations to be executed, to change a bit pattern of the plurality of first bit data to generate a plurality of second bit data; and
an encoder connected to the wiring network to convert the plurality of second bit data generated by the wiring network into at least one or at least two binary output data.

2. The logic circuit according to claim 1, wherein the Hamming weight of each of the plurality of first bit data is one, or two or more.

3. The logic circuit according to claim 2, wherein the wiring network has a plurality of switch elements,
the plurality of switch elements are divided into a plurality of groups, and
the wiring network includes a first group receiving the plurality of first bit data and a second group receiving outputs from the plurality of switch elements in the first group.

4. The logic circuit according to claim 3, wherein each of the plurality of switch elements has two input ends, two output ends, and two control input ends to which the control input and the second input data are input, and
each of the switch elements is capable of changing two bit data in the plurality of first bit data input to the two input ends in accordance with the control input and the second input data, to output the resultant bit data from the two output ends.

5. The logic circuit according to claim 1, wherein the first and second logical calculations are logical calculations of an exclusive logical sum and a logical product, respectively.

6. The logic circuit according to claim 2, wherein the first and second logical calculations are logical calculations of an exclusive logical sum and a logical product, respectively.

7. The logic circuit according to claim 3, wherein the first and second logical calculations are logical calculations of an exclusive logical sum and a logical product, respectively.

8. The logic circuit according to claim 4, wherein the first and second logical calculations are logical calculations of an exclusive logical sum and a logical product, respectively.

9. The logic circuit according to claim 1, wherein the decoder includes a plurality of AND circuits.

10. The logic circuit according to claim 2, wherein the decoder includes a plurality of AND circuits.

11. A logic circuit capable of executing a combination of a plurality of logical calculations on at least three input data, the logic circuit comprising:
a decoder converting one, or two or more first binary input data into a plurality of first bit data having a constant Hamming weight regardless of the Hamming weight of the first input data;
a first wiring network connected to the decoder to receive the plurality of first bit data into which the first input data has been converted by the decoder and to change bit positions of the plurality of received first bit data in accordance with a first control input and second input data specifying which of two logical calculations based on different logical calculation functions is to execute, to change a bit pattern of the plurality of first bit data to generate a plurality of second bit data;
a second wiring network connected to the first wiring network to receive the plurality of second bit data generated by the first wiring network and to change bit positions of the plurality of received second bit data in accordance with a second control input and third input data specifying which of two logical calculations based on different logical calculation functions is to execute, to change a bit pattern of the plurality of second bit data to generate a plurality of third bit data; and
an encoder connected to the second wiring network to convert the plurality of third bit data generated by the second wiring network into one, or two or more binary output data.

12. The logic circuit according to claim 11, wherein the Hamming weight of each of the plurality of first bit data is one, or two or more.

13. The logic circuit according to claim 12, wherein each of the first and second wiring networks has a plurality of switch elements,
the plurality of switch elements in each of the first and second wiring networks are divided into a plurality of groups,
the first wiring network includes a first group receiving the plurality of first bit data and a second group receiving outputs from the plurality of switch elements in the first group, and
the second wiring network includes a third group receiving the plurality of second bit data and a fourth group receiving outputs from the plurality of switch elements in the third group.

14. The logic circuit according to claim 13, wherein each of the plurality of switch elements in the first wiring network has two first input ends, two first output ends, and two first control input ends to which the control input and the second input data are input,
each of the switch elements in the first wiring network is capable of changing two bit data in the plurality of first bit data input to the two first input ends in accordance with the control input and the second input data, to output the resultant bit data from the two first output ends,
each of the plurality of switch elements in the second wiring network has two second input ends, two second output ends, and two second control input ends to which the control input and the third input data are input, and
each of the switch elements in the second wiring network is capable of changing two bit data in the plurality of second bit data input to the two first input ends in accordance with the control input and the third input data, to output the resultant bit data from the two second output ends.

15. The logic circuit according to claim 11, wherein the two different logical calculations are logical calculations of an exclusive logical sum and a logical product, respectively.

16. The logic circuit according to claim 12, wherein the two different logical calculations are logical calculations of an exclusive logical sum and a logical product, respectively.

17. The logic circuit according to claim 13, wherein the two different logical calculations are logical calculations of an exclusive logical sum and a logical product, respectively.

18. The logic circuit according to claim 14, wherein the two different logical calculations are logical calculations of an exclusive logical sum and a logical product, respectively.

19. The logic circuit according to claim 11, wherein the decoder includes a plurality of AND circuits.

20. The logic circuit according to claim 12, wherein the decoder includes a plurality of AND circuits.
